(19) United States
(12) Patent Application Publication
(10) Pub. No.: US 2023/0368669 A1
(43) Pub. Date: Nov. 16, 2023

(54) COMMUNICATION APPARATUSES AND COMMUNICATION METHODS FOR GEOLOCATION-BASED BROADCAST MESSAGE FOR VULNERABLE ROAD USERS

(71) Applicant: Panasonic Intellectual Property Corporation of America, Torrance, CA (US)

(72) Inventors: Yang KANG, Singapore (SG); Hidetoshi SUZUKI, Kanagawa (JP); Hong Cheng, Michael SIM, Singapore (SG); Xuan Tuong TRAN, Singapore (SG)

(21) Appl. No.: 18/249,706

(22) PCT Filed: Jul. 15, 2021
(86) PCT No.: PCT/SG2021/050416

§ 371 Date: Apr. 19, 2023

(30) Foreign Application Priority Data
Oct. 22, 2020 (SG) 10202010503R

(51) Int. Cl. G08G 1/16; H04W 4/021; H04W 4/06; H04W 52/02; H04W 76/28

(52) U.S. Cl. CPC G08G 1/164; G08G 1/166; H04W 4/021; H04W 4/06; H04W 52/0225; H04W 76/28

(57) ABSTRACT

The present disclosure provides communication apparatuses and communication methods for geolocation-based broadcast message for vulnerable road users. The communication apparatuses include a communication apparatus comprising: circuitry which, in operation, identifies a geographical zone based on a location of the communication apparatus; and a transmitter which, in operation, transmits a signal based on the geographical zone.

### TECHNICAL FIELD

The following disclosure relates to communication apparatuses and communication methods for geolocation-based broadcast message, and more particularly to communication apparatuses and communication methods for geolocation-based broadcast message for vulnerable road users.

### BACKGROUND

Sidelink (SL) communication allows vehicles to interact with public roads and other road users through vehicle-to-everything (V2X) applications, and is thus considered a critical factor in making autonomous vehicles a reality. Other SL applications include P2P or I2P (infrastructure to pedestrian, or R2P roadside unit to pedestrian) communications.

Further, 5G NR based SL communications (interchangeably referred to as NR SL communications) is being discussed by the 3rd Generation Partnership Project (3GPP) to identify technical solutions for advanced V2X services, through which vehicles (i.e. interchangeably referred to as communication apparatuses or user equipments (UEs) that support V2X applications) can exchange their own status information through SL with other nearby vehicles, infrastructure nodes and/or pedestrians. The status information includes information on position, speed, heading, etc.

However, there has been no discussion on communication apparatuses and methods for geolocation-based broadcast message for vulnerable road users.

There is thus a need for communication apparatuses and methods that provide feasible technical solutions for geolocation-based broadcast messages for vulnerable road users. Furthermore, other desirable features and characteristics will become apparent from the subsequent detailed description and the appended claims, taken in conjunction with the accompanying drawings and this background of the disclosure.

### SUMMARY

Non-limiting and exemplary embodiment facilitates providing communication apparatuses and methods for geolocation-based broadcast messages for vulnerable road users.

According to a first embodiment of the present disclosure, there is provided a communication apparatus comprising: circuitry, which in operation, identifies a geographical zone based on a location of the communication apparatus; and a transmitter, which in operation, transmits a signal based on the geographical zone.

According to a second embodiment of the present disclosure, there is provided a communication method comprising: identifying a geographical zone based on a location of a communication apparatus; and transmitting a signal based on the geographical zone.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR-RAN architecture.

FIG. 2 depicts a schematic drawing which shows functional split between NG-RAN and 5GC.

FIG. 3 depicts a sequence diagram for RRC connection setup/reconfiguration procedures.

FIG. 4 depicts a schematic drawing showing usage scenarios of Enhanced mobile broadband (eMBB), Massive Machine Type Communications (mMTC) and Ultra Reliable and Low Latency Communications (URLLC).

FIG. 5 shows a block diagram showing an exemplary 5G system architecture for V2X communication in a non-roaming scenario.

FIG. 6 depicts a flow diagram 600 illustrating how a geolocation based message or signal may be broadcasted according to various embodiments.

FIG. 7 shows an illustration 700 of how a road junction may be segregated into geographical zones according to various embodiments.

FIG. 8 shows another illustration 800 of how a road junction may be segregated into geographical zones according to various embodiments.

FIG. 9 shows an illustration 900 of a hysteresis zone according to various embodiments.

FIG. 10 shows a diagram 1000 illustrating how zone-specific resources may be segregated according to various embodiments.

FIG. 11 shows an illustration 1100 of how zone-specific resources may be utilised according to various embodiments.

FIG. 12 shows another illustration 1200 of how zone-specific resources may be utilised according to various embodiments.

FIG. 13 shows a flow diagram 1300 illustrating a communication method according to various embodiments.

FIG. 14 shows a schematic example of communication apparatus 1400 in accordance with various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

3GPP has been working at the next release for the 5^{th} generation cellular technology, simply called 5G, including the development of a new radio access technology (NR) operating in frequencies ranging up to 100 GHz. The first version of the 5G standard (rel. 15) was completed at the end of 2017, which allows proceeding to 5G NR standard-compliant trials and commercial deployments of smartphones. A recent version (rel. 16) was released in June 2020, which brings IMT-2020 submission for an initial full 3GPP 5G system to its completion and enabling more advanced features for sidelink communications.

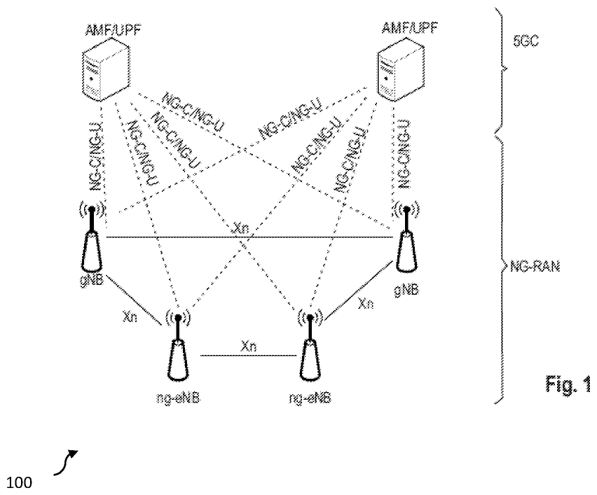

Among other things, the overall system architecture assumes an NG-RAN (Next Generation—Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v16.3.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300. Further, sidelink communications is introduced in 3GPP TS 38.300 v16.3.0. Sidelink supports UE-to-UE direct communication using the sidelink resource allocation modes, physical-layer signals/channels, and physical layer procedures (see for instance section 5.7 of TS 38.300).

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH(Physical Uplink Shared Channel) and PUCCH(Physical Uplink Control Channel) for uplink and PDSCH(Physical Downlink Shared Channel), PDCCH(Physical Downlink Control Channel) and PBCH(Physical Broadcast Channel) for downlink. Further, physical sidelink channels include Physical Sidelink Control Channel (PSCCH), Physical Sidelink Shared Channel (PSSCH), Physical Sidelink Feedback Channel (PSFCH) and Physical Sidelink Broadcast Channel (PSBCH).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than a mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

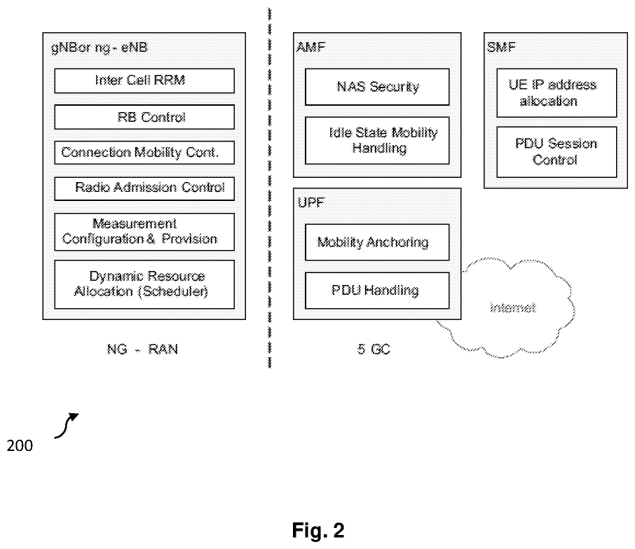

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

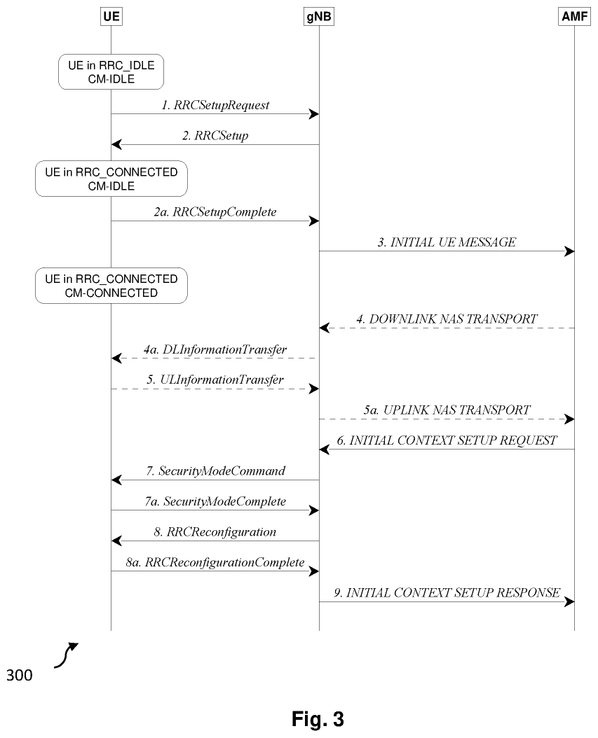

FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE. 2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502 reference [22] (3GPP TS 23.122: “Non-Access-Stratum (NAS) functions related to Mobile Station in idle mode”).
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

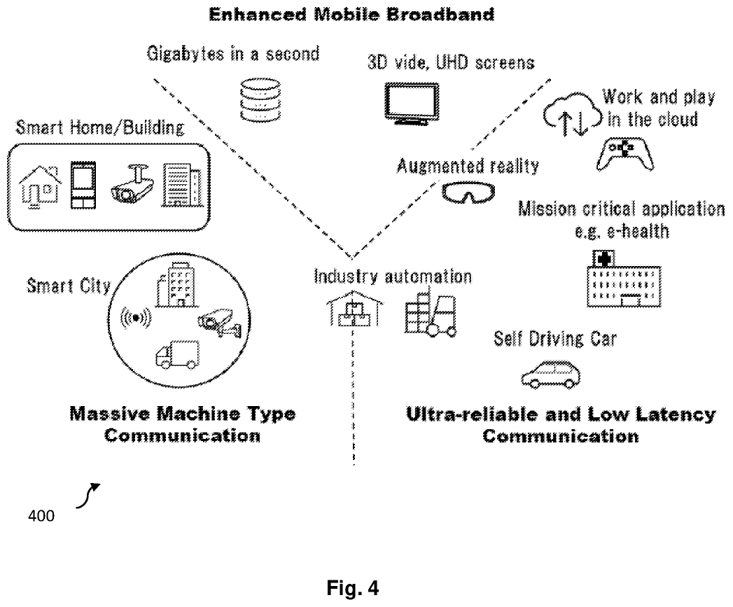

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10-6 level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

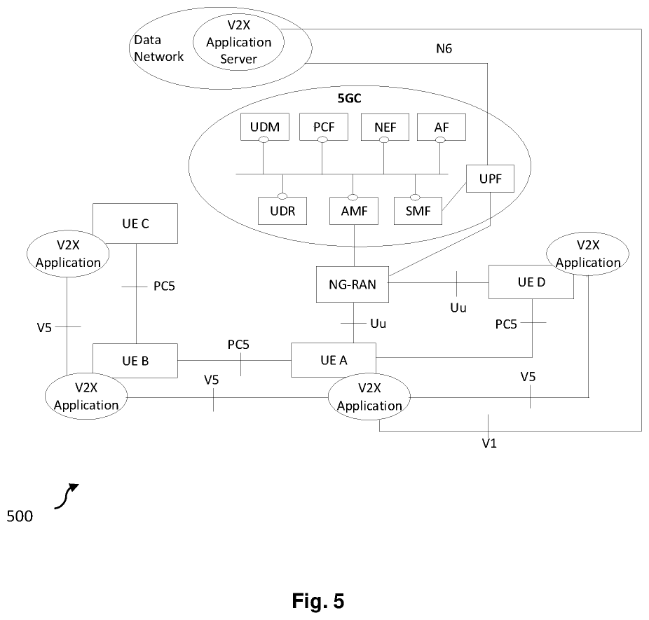

FIG. 5 illustrates a 5G NR non-roaming reference architecture (see TS 23.287 v16.4.0, section 4.2.1.1). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or 3rd party services. All of or a part of the core network functions and the application services may be deployed and running on cloud computing environments.

In the present disclosure, an application server (for example, V2X Application Server in FIG. 5) may be provided to handle QoS requirements for V2X communications as per defined in Section 5.4 of TS23.287.

Power saving for UEs has been discussed in rel.17 V2X WID (RP-201385). Power saving enables UEs with battery constraint to perform sidelink operations in a power efficient manner. Rel-16 NR sidelink is designed based on the assumption of “always-on” when UE operates sidelink, e.g., only focusing on UEs installed in vehicles with sufficient battery capacity. Solutions for power saving in Rel-17 are required for vulnerable road users (VRUs) in V2X use cases and for UEs in public safety and commercial use cases where power consumption in the UEs needs to be minimized.

According to ETSI TR 103 300-1, the following types of road users are considered as vulnerable road users.
Pedestrians (including children, elderly, joggers).
Emergency responders, safety workers, road workers.
Animals such as horses, dogs down to relevant wild animals (see note below).
Wheelchairs users, prams.
Skaters, Skateboards, Segway, potentially equipped with an electric engine.
Bikes and e-bikes with speed limited to 25 km/h (e-bikes, class L1e-A [i.8]).
High speed e-bikes speed higher than 25 km/h, class L1e-B [i.8].
Powered Two Wheelers (PTW), mopeds (scooters), class L1e [i.8].
PTW, motorcycles, class L3e [i.8];
PTW, tricycles, class L2e, L4e and L5e [i.8] limited to 45 km/h;
PTW, quadricycles, class L5e and L6e [i.8] limited to 45 km/h.
NOTE: Relevant wild animals are only those which present a safety risk to other road users (VRUs, vehicles)

The classification in Annex 1 of Regulation (EU) 168/2013 [i.8] may also be considered.

For the safety concern of VRUs as shown in the above list, the most fundamental step is the detection of the VRU presence. ETSI TS103 300-2 presents various use cases concerning VRU presence detection as follows:
1) Detection of the VRU presence:
VRU self-positioning. The VRU has sensors and potentially other sources allowing it to determine its own properties, including its location and velocity.
Another road user (e.g. a V-ITS-S) detects and tracks the VRU.
Roadside equipment connected to an R-ITS-S or a central ITS-S detects and tracks the VRU.
2) Evaluation whether the VRU is at potential risk from other road users and VRU position and dynamic state should be transmitted. Any party may transmit information about VRUs that it is aware of. Information on VRUs should be filtered and only be transmitted according to the message triggering conditions. The potential risk from other road users depends on the following conditions, among others:
Presence of other road users.
Road layout.
Dynamic state of the VRU and the other road users.
Traffic signal status for both VRU and vehicles, if relevant, and compliance to traffic lights.
3) Evaluation of safety message environment, specifically whether the VRU is part of a cluster, to determine whether the VRU's own ITS-S should transmit.
4) Transmission of information about VRU at-risk:
VRU sends ego-status information.
VRU cluster leader sends cluster information.
V-ITS-S, R-ITS-S, C-ITS-S or another road user sends information about a VRU in a potential risk situation.
5) Risk assessment. Phases (receiver side):
Fusion of sensor data, and observed information transmitted by other road users to build a local dynamic map, with information about road users' location, velocity and potentially other data, e.g. intention.
Assessment of risk based on estimated trajectory and velocity of different road users.
6) Warning or action to protect the VRU:
Warning of the device carrier (VRU or any other road user).
Transmission of collision warning to other road users.
Action in the case of an automated vehicle.

From a radio perspective, a broadcast to indicate a VRU's presence would be necessary to alert vehicle UEs (V-UEs) to take caution.

Further, it is not clear how a VRU-UE should trigger SL broadcast to indicate its presence. For example, in LTE-V2X, a BSM (basic safety message) is broadcasted by vehicular UEs at a periodicity of at least 10 ms. However, it is not suitable for the VRU-UEs to keep broadcasting as they may not be required to transmit broadcast at safer places, e.g., at home, in offices, etc. in order to reduce power consumption.

To address the above issue, broadcasts may be triggered when a VRU-UE enters or is inside a certain geographical zone. The geographical zones may be categorized by a parameter associated with danger levels. The VRU-UE identifies its geographical zone through Global Navigation Satellite System (GNSS) checking. Advantageously, VRU-UEs can be configured to transmit broadcasts in geographical zones that are considered more dangerous and not transmit in safe geographical zones, thus saving power for the VRU-UEs.

A parameter “DangerZoneIndicator” may be (pre-)configured to VRU-UEs for geographical zones, for instance
DangerZoneIndicator=0 indicates a danger zone
DangerZoneIndicator=1 indicates a safe zone

A VRU-UE should periodically check the associated geographical zone and/or DangerZoneIndicator by using its GNSS location and pre-loaded map data. The VRU-UE should then do a SL broadcast if it is inside a danger zone (i.e. DangerZoneIndicator=0). It will be appreciated that the values for the DangerZoneIndicator may be configured in other ways. For example, a value of 0 may indicate a safe zone, while a value of 1 may indicate a danger zone instead. Further, the parameter name is not limited to DangerZoneIndicator and may be named differently. The parameter may be indicated by RRC, MAC or even PHY layer signalling.

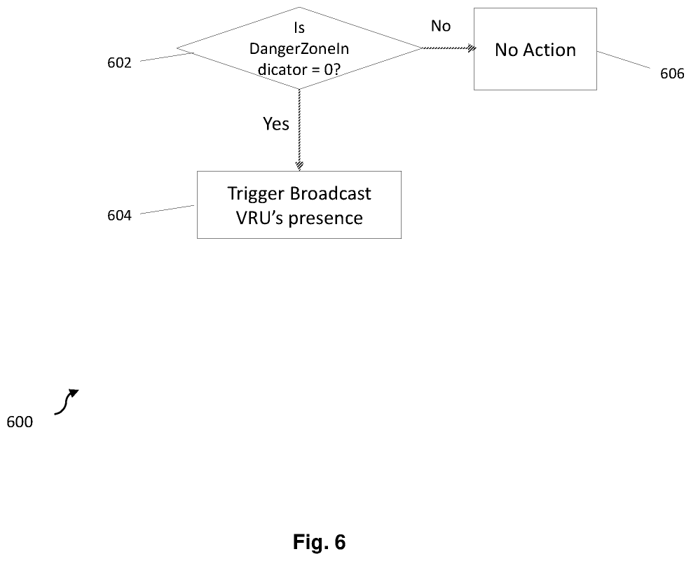

FIG. 6 depicts a flow diagram 600 illustrating how a geolocation based message or signal may be broadcasted according to various embodiments. At step 602, it is determined whether the value of a DangerZoneIndicator associated with a geographical zone is 0. If it is determined to be so, the process proceeds to step 604 where a broadcast indicating a VRU's presence in the concerned geographical zone is triggered. Otherwise, the process proceeds from 602 to 606 where no action is taken to transmit or broadcast the VRU's presence in the concerned geographical zone. In an example, a message or signal may be transmitted at step 604 indicating the concerned geographical zone.

The DangerZoneIndicator may indicate one of multiple values instead of just 0 or 1, for example, the DangerZoneIndicator may indicate a value based on a degree of danger of the associated geographical zone:
DangerZoneIndicator=0: most dangerous, e.g., inside road zone;
DangerZoneIndicator=1: dangerous, e.g., within 1 m of roadside;
DangerZoneIndicator=2: less dangerous, e.g., beyond 1 m of roadside;
DangerZoneIndicator=3: safe, e.g., inside a building.

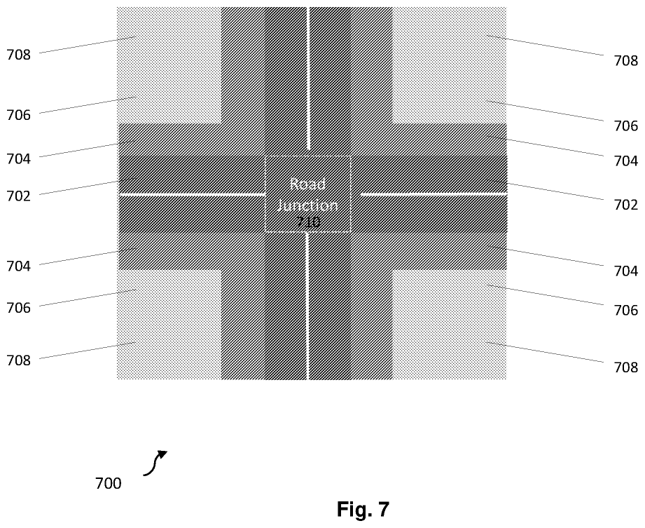

FIG. 7 shows an illustration 700 of how a road junction 710 may be segregated into geographical zones according to various embodiments. The areas labelled with ref 702 are inside the road zone of the road junction 710 and may have a DangerZoneIndicator value of 0 (i.e. most dangerous). The areas labelled with ref 704 are within 1 metre of the roadside of the road junction 710 and may have a DangerZoneIndicator value of 1 (i.e. dangerous). The areas labelled with ref 706 are beyond 1 metre from the roadside of the road junction 710 and may have a DangerZoneIndicator value of 2 (i.e. less dangerous). The areas labelled with ref 708 are inside a building and may have a DangerZoneIndicator value of 3 (i.e. safe).

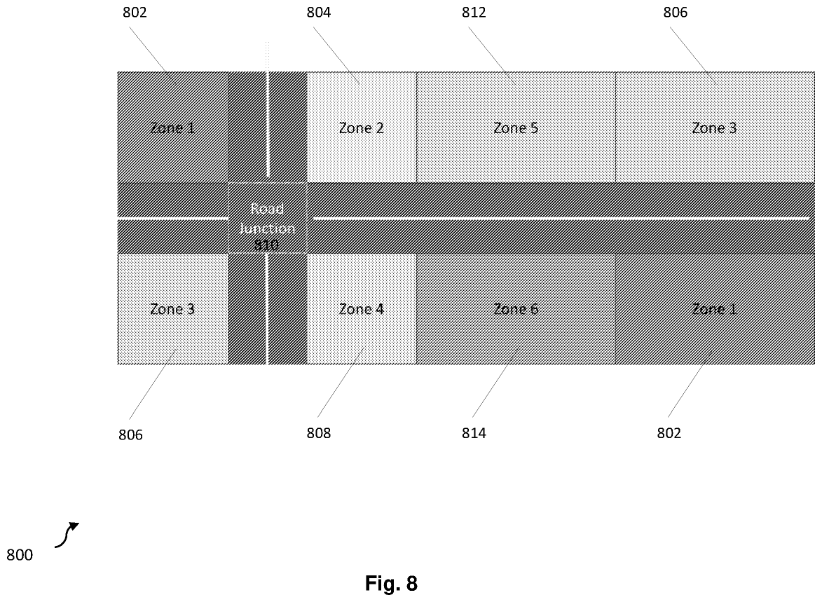

FIG. 8 shows another illustration 800 of how a road junction 810 may be segregated into geographical zones according to various embodiments. For example, the road junction 810 may be segregated into zone 1 802, zone 2 804, zone 3 806, zone 4 808, zone 5 812 and zone 6 814, wherein each zone may be associated with a danger level indicator such as the DangerZoneIndicator parameter.

As can be seen in illustrations 700 and 800 of FIG. 7 and FIG. 8 respectively, the geographical zones may be grid-shaped or flexible-shaped depending on how segregation of an area into geographical zones is desired. The geographical zones may further include altitude such that segregation is done on a three-dimensional basis. For example, each level of a building may be segregated into different geographical zones. Each geographical zone may also be associated with a danger level, wherein different danger levels may be further associated with different power saving modes such as deep sleep, light sleep, micro-sleep or other similar modes. For example, a VRU-UE located in a geographical zone corresponding to deep-sleep power saving mode may be configured to adopt the deep-sleep power saving mode. When the VRU-UE enters another geographical zone corresponding to a light sleep power saving mode, the VRU-UE adopts the light sleep power saving mode accordingly. Advantageously, this enables the VRU-UE to save power when located in the designated geographical zones, for instance more power can be saved when located in safer geographical zones.

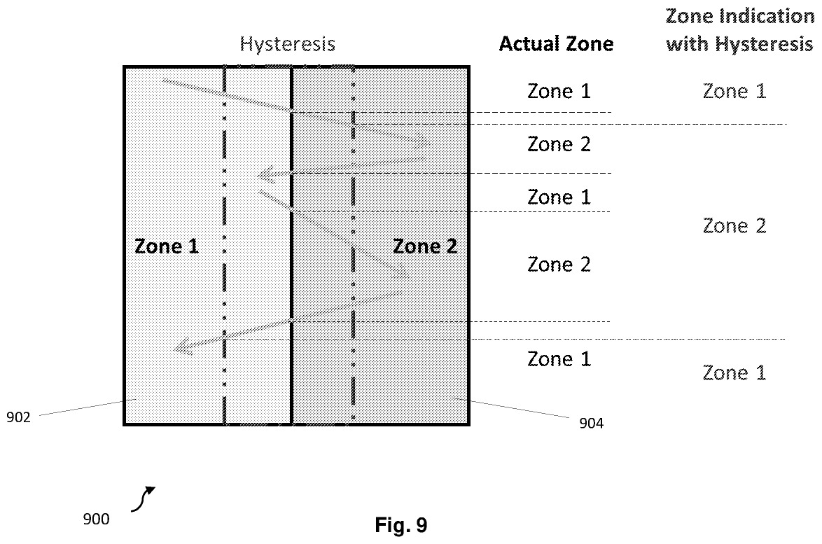

In an example, a hysteresis region or zone (e.g., 1 m) can also be configured at the boundaries between two geographical zones. In some situations, a VRU-UE may frequently zone switch between two zones, for example as shown in the zigzag pattern of illustration 900 in FIG. 9. The VRU-UE may then transmit a message or signal indicating zone 1 when entering zone 1 902, transmit another message or signal indicating zone 2 when exiting zone 1 902 and entering zone 2 904, transmit a further message indicating zone 1 when exiting zone 2 904 and reentering zone 1 902. Such indications may be confusing if the messages are sent in quick succession depending on how fast the VRU-UE is moving. The hysteresis region may thus be configured between the two zones to avoid such indications of frequent zone switching between zone 1 902 and zone 2 904. For example, a VRU-UE originally at zone 1 902 may be configured to transmit a message or signal indicating zone 2 904 only after it has crossed the hysteresis region at the zone 2 904 side. Likewise, a VRU-UE originally at zone 2 904 may be configured to transmit a message or signal indicating zone 1 902 only after it has crossed the hysteresis region at the zone 1 902 side. The VRU-UE may be further configured to transmit the message or signal at a slower frequency when it is inside or has crossed the hysteresis region, or it may be configured to transmit the message or signal only after it has crossed the hysteresis region and/or been inside a zone for a pre-configured period of time. The hysteresis region advantageously avoids confusing indication of frequent zone switching by the VRU-UE, as well as reduces the number of transmissions by the VRU-UE and thus saves power.

Transmission of a message or signal indicating a geographical zone by a VRU-UE may be configured to be more frequent when the VRU-UE is in a more dangerous zone. In detail, an operation to achieve this would be using a multiplier parameter or (pre-)configured periodic timings. For example, a parameter “drxCycleMultiplier” may be used. The parameter “drxCycleMultiplier” can be a parameter list and linked with different danger levels to multiply with existing discontinuous reception (DRX) cycles, for example:
drxCycleMultiplier=1, for DangerZoneIndicator=0 (most dangerous);
drxCycleMultiplier =2, for DangerZoneIndicator=1 (dangerous);
drxCycleMultiplier =5, for DangerZoneIndicator=2 (less dangerous);
drxCycleMultiplier =10, for DangerZoneIndicator=3 (safe)

It will be appreciated that the parameter name is not limited to drxCycleMultiplier and may be named differently.

In urban areas, there is usually dense population and many VRUs (i.e.

pedestrians) may gather in business districts or commercial zones. This may result in high chances of traffic collision and huge waste of resources if all VRU-UEs wish to broadcast its presence. Thus, a listen-before-talk (LBT) period can be designed for VRU-UEs for power saving and/or resource efficiency purposes. A VRU-UE would not transmit its safety message or signal or indicate its presence if a broadcast from other VRU-UE in proximity is detected within its LBT period. It can be realized by higher layer (i.e. Operation A) or physical layer (i.e. Operation B).

Under Operation A, a parameter “SL-LBTperiod” may be (pre-)configured or predefined to a VRU UE indicating a LBT period that is prior to a VRU-UE's transmission occasion i.e. prior to transmission of a message or signal indicating an associated geographical zone. The VRU-UE would receive other UEs' SL transmission in its LBT period. The decoding results are reported to higher layer (MAC or RRC) and the respective higher layer would then decide whether to perform the consequent SL broadcast i.e. whether to transmit the message or signal indicating the associated geographical zone. It will be appreciated that the parameter name is not limited to SL-LBTperiod and may be named differently.

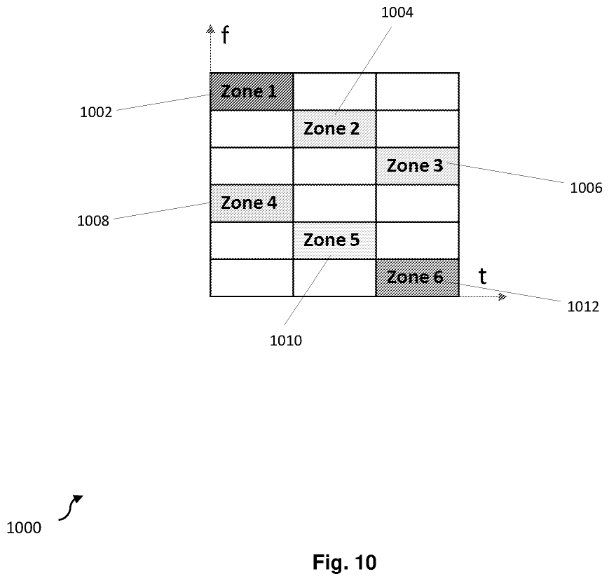

Under Operation B, geo-location/zone specific resources may be (pre-) configured for different geographical zones. All VRU-UEs within the same zone should use the same specific resource to indicate its presence i.e. use the same resource to transmit the message or signal indicating an associated geographical zone. FIG. 10 shows a diagram 1000 illustrating how zone-specific resources may be segregated according to various embodiments. For example, zone-specific resource 1002 will be used only for VRU-UEs in zone 1, zone-specific resource 1004 will be used only for VRU-UEs in zone 2, zone-specific resource 1006 will be used only for VRU-UEs in zone 3, zone-specific resource 1008 will be used only for VRU-UEs in zone 4, zone-specific resource 1010 will be used only for VRU-UEs in zone 5, and zone-specific resource 1012 will be used only for VRU-UEs in zone 6. Only 1-bit is carried by sequence in the zone-specific resource, thus multiple UEs' transmission can be overlapped for V-UEs' reception (PSFCH can be re-used).

Further, an LBT period may be (pre-)configured or predefined to a VRU-UE under Operation B. The LBT period may include the VRU-UE's last transmission occasion. If the VRU-UE receives other UE's indication in the same zone (determined by GNSS location), the VRU-UE will not broadcast its presence in the subsequent transmission occasions.

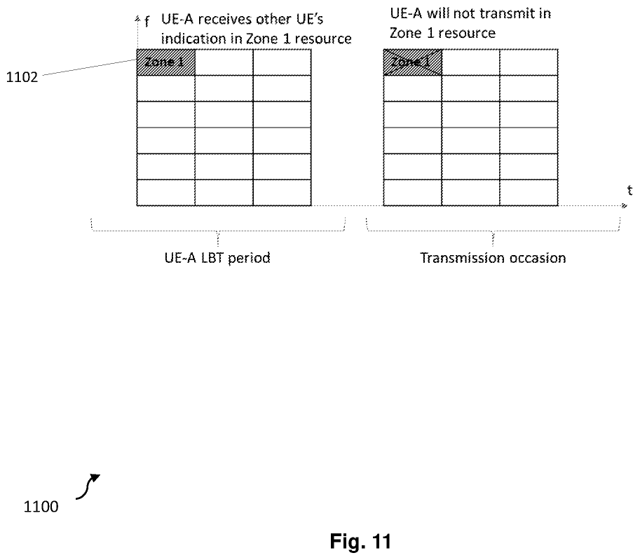

FIG. 11 shows an illustration 1100 of how zone-specific resources may be utilised according to various embodiments. For example, a VRU-UE in a zone 1 may receive another UE's message or signal, wherein the message or signal is sent using a zone-specific resource that is allocated to zone 1 resource 1102. Accordingly, the VRU-UE will not broadcast its presence in zone 1 in its subsequent transmission occasion.

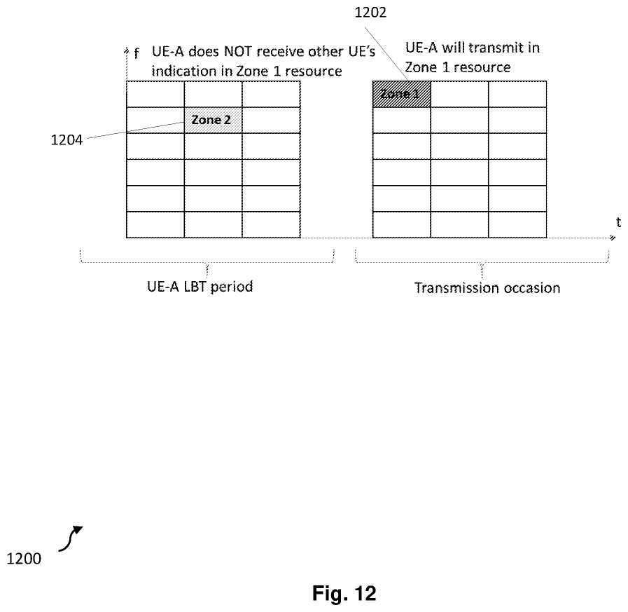

FIG. 12 shows another illustration 1200 of how zone-specific resources may be utilised according to various embodiments. For example, a VRU-UE in a zone 1 may receive another UE's message or signal, wherein the message or signal is sent using a zone-specific resource that is allocated to another zone i.e. zone 2 resource 1204. However, the VRU-UE does not receive any message, signal or indication sent using zone 1 resource 1202 from other UEs. Accordingly, the VRU-UE proceeds to broadcast its presence in zone 1 using the zone 1 resource 1202 in its subsequent transmission occasion.

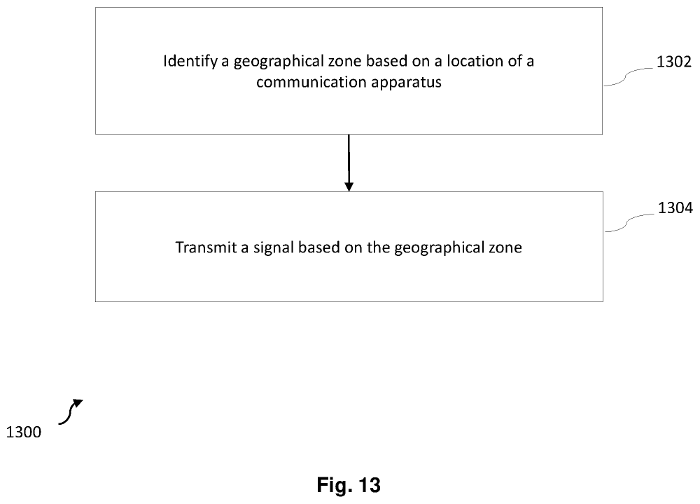

FIG. 13 shows a flow diagram 1300 illustrating a communication method according to various embodiments. In step 1302, a geographical zone based on a location of a communication apparatus is identified. In step 1304, a signal based on the geographical zone is transmitted.

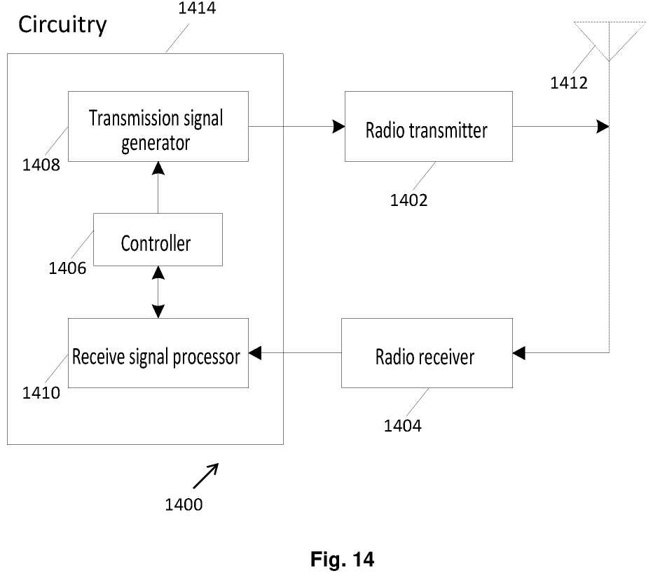

FIG. 14 shows a schematic, partially sectioned view of the communication apparatus 1400 that can be implemented for geolocation-based broadcast message for vulnerable road users in accordance with various embodiments and examples as shown in FIGS. 1 to 13. The communication apparatus 1400 may be implemented as a UE, V-UE or a VRU-UE according to various embodiments.

Various functions and operations of the communication apparatus 1400 are arranged into layers in accordance with a hierarchical model. In the model, lower layers report to higher layers and receive instructions therefrom in accordance with 3GPP specifications. For the sake of simplicity, details of the hierarchical model are not discussed in the present disclosure.

As shown in FIG. 14, the communication apparatus 1400 may include circuitry 1414, at least one radio transmitter 1402, at least one radio receiver 1404, and at least one antenna 1412 (for the sake of simplicity, only one antenna is depicted in FIG. 14 for illustration purposes). The circuitry 1414 may include at least one controller 1406 for use in software and hardware aided execution of tasks that the at least one controller 1406 is designed to perform, including control of communications with one or more other communication apparatuses in a wireless network. The circuitry 1414 may furthermore include at least one transmission signal generator 1408 and at least one receive signal processor 1410. The at least one controller 1406 may control the at least one transmission signal generator 1408 for generating signals (for example, a signal indicating a geographical zone) to be sent through the at least one radio transmitter 1402 to one or more other communication apparatuses and the at least one receive signal processor 1410 for processing signals (for example, a signal indicating a geographical zone) received through the at least one radio receiver 1404 from the one or more other communication apparatuses under the control of the at least one controller 1406. The at least one transmission signal generator 1408 and the at least one receive signal processor 1410 may be stand-alone modules of the communication apparatus 1400 that communicate with the at least one controller 1406 for the above-mentioned functions, as shown in FIG. 14. Alternatively, the at least one transmission signal generator 1408 and the at least one receive signal processor 1410 may be included in the at least one controller 1406. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1402, at least one radio receiver 1404, and at least one antenna 1412 may be controlled by the at least one controller 1406.

The communication apparatus 1400, when in operation, provides functions required for geolocation-based broadcast message for vulnerable road users. For example, the communication apparatus 1400 may be a UE, V-UE or VRU-UE, and the circuitry 1414 may, in operation, identify a geographical zone based on a location of the communication apparatus 1400. The transmitter 1402 may, in operation, transmit a signal based on the geographical zone.

The circuitry 1414 may be further configured to identify the geographical zone based on a Global Navigation Satellite System (GNSS) location of the communication apparatus 1400 and pre-loaded map data. The geographical zone may be associated with either a danger zone or a safe zone, and wherein the transmitter 1402 may be further configured to transmit the signal when the geographical zone is associated with a danger zone.

The geographical zone may be associated with one of a plurality of danger levels, and wherein the transmitter 1402 may be further configured to transmit the signal based on the associated danger level. Each danger level of the plurality of danger levels may be associated with a power saving mode, and wherein the circuitry 1414 may be further configured to activate a power saving mode for the communication apparatus 1400 that is the same as a power saving mode associated with the associated danger level. Each danger level of the plurality of danger levels may be associated with a multiplier parameter or pre-configured periodic timing, wherein the transmitter 1402 may be further configured to transmit the signal at a periodicity based on the multiplier parameter or pre-configured periodic timing. The circuitry 1414 may be further configured to multiply a discontinuous reception (DRX) cycle associated with the communication apparatus 1400 with the multiplier parameter, and wherein the transmitter 1402 may be further configured to transmit the signal based on the multiplied DRX cycle. The associated danger level may indicate how dangerous the geographical zone is, and wherein the transmitter may be further configured to transmit the signal more or less frequently if the associated danger level indicates the geographical zone as more or less dangerous. The geographical zone may be grid-shaped, flexible-shaped and/or includes an altitude of the communication apparatus 1400.

A hysteresis region may be designated at a boundary between two geographical zones, such that the signal may be transmitted less frequently when the communication apparatus is frequently zone switching between the two geographical zones.

The receiver 1404 may, in operation, receive another signal from another communication apparatus at a predefined period prior to the transmission of the signal, wherein the circuitry 1414 may be further configured to decode the another signal for a determination by a higher layer on whether to transmit the signal; and wherein the transmitter 1402 may be further configured to transmit the signal based on the determination.

The receiver 1404 may, in operation, receive another signal from another communication apparatus at a predefined period prior to the transmission of the signal, the another signal indicating another geographical zone, wherein the transmitter 1402 may be further configured to not transmit the signal if the another geographical zone is the same as the geographical zone.

Each geographical zone may be allocated a zone-specific resource, such that the communication apparatus 1400 may use a zone-specific resource allocated to the geographical zone for transmission of the signal, and/or another communication apparatus may use the zone-specific resource allocated to the geographical zone for transmission of another signal, the another signal indicating another geographical zone, if the another geographical zone is the same as the geographical zone. The receiver 1404 may, in operation, receive the another signal from the another communication apparatus at a predefined period prior to transmission of the signal, wherein the transmitter 1402 may be further configured to not transmit the signal if it is determined that the another signal is transmitted using the zone-specific resource allocated to the geographical zone.

The signal may be a broadcast indicating the geographical zone. The communication apparatus 1400 may be a vulnerable road user equipment (VRU-UE).

(Control Signals)

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sildelink control information (SCI) or the 2nd stage SCI.

(Base Station)

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

(Uplink/Downlink/Sidelink)

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

(Data Channels/Control Channels)

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

(Reference Signals)

In the present disclosure, the reference signals are signals known to both a base station and a mobile station and each reference signal may be referred to as a Reference Signal (RS) or sometimes a pilot signal. The reference signal may be any of a DMRS, a Channel State Information—Reference Signal (CSI-RS), a Tracking Reference Signal (TRS), a Phase Tracking Reference Signal (PTRS), a Cell-specific Reference Signal (CRS), and a Sounding Reference Signal (SRS).

(Time Intervals)

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

(Frequency Bands)

The present disclosure may be applied to any of a licensed band and an unlicensed band.

(Communication)

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

(Antenna Ports)

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

As described above, the embodiments of the present disclosure provide an advanced communication system, communication methods and communication apparatuses for geolocation-based broadcast message for vulnerable road users that advantageously enables power saving in VRU-UEs.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
circuitry, which in operation, identifies a geographical zone based on a location of the communication apparatus; and
a transmitter, which in operation, transmits a signal based on the geographical zone.

2. The communication apparatus according to claim 1, wherein the circuitry is further configured to identify the geographical zone based on a Global Navigation Satellite System (GNSS) location of the communication apparatus and pre-loaded map data.

3. The communication apparatus according to claim 1, wherein the geographical zone is associated with either a danger zone or a safe zone, and wherein the transmitter is further configured to transmit the signal when the geographical zone is associated with a danger zone.

4. The communication apparatus according to claim 1, wherein the geographical zone is associated with one of a plurality of danger levels, and wherein the transmitter is further configured to transmit the signal based on the associated danger level.

5. The communication apparatus according to claim 4, wherein each danger level of the plurality of danger levels is associated with a power saving mode, and wherein the circuitry is further configured to activate a power saving mode for the communication apparatus that is the same as a power saving mode associated with the associated danger level.

6. The communication apparatus according to claim 4, wherein each danger level of the plurality of danger levels is associated with a multiplier parameter or pre-configured periodic timing, wherein the transmitter is further configured to transmit the signal at a periodicity based on the multiplier parameter or pre-configured periodic timing.

7. The communication apparatus according to claim 6, wherein the circuitry is further configured to multiply a discontinuous reception (DRX) cycle associated with the communication apparatus with the multiplier parameter, and wherein the transmitter is further configured to transmit the signal based on the multiplied DRX cycle.

8. The communication apparatus according to claim 4, wherein the associated danger level indicates how dangerous the geographical zone is, and wherein the transmitter is further configured to transmit the signal more or less frequently if the associated danger level indicates the geographical zone as more or less dangerous.

9. The communication apparatus according to claim 1, wherein the geographical zone is grid-shaped, flexible-shaped and/or includes an altitude of the communication apparatus.

10. The communication apparatus according to claim 1, wherein a hysteresis region is designated at a boundary between two geographical zones, such that the signal is transmitted less frequently when the communication apparatus is frequently zone switching between the two geographical zones.

11. The communication apparatus according to claim 1, further comprising:
a receiver, which in operation, receives another signal from another communication apparatus at a predefined period prior to the transmission of the signal;
wherein the circuitry is further configured to decode the another signal for a determination by a higher layer on whether to transmit the signal; and
wherein the transmitter is further configured to transmit the signal based on the determination.

12. The communication apparatus according to claim 1, further comprising:
a receiver, which in operation, receives another signal from another communication apparatus at a predefined period prior to transmission of the signal, the another signal indicating another geographical zone,
wherein the transmitter is further configured to not transmit the signal if the another geographical zone is the same as the geographical zone.

13. The communication apparatus according to claim 1, wherein each geographical zone is allocated a zone-specific resource, such that the communication apparatus uses a zone-specific resource allocated to the geographical zone for transmission of the signal, and/or another communication apparatus uses the zone-specific resource allocated to the geographical zone for transmission of another signal, the another signal indicating another geographical zone, if the another geographical zone is the same as the geographical zone.

14. The communication apparatus according to claim 13, further comprising:
a receiver, which in operation, receives the another signal from the another communication apparatus at a predefined period prior to transmission of the signal,
wherein the transmitter is further configured to not transmit the signal if it is determined that the another signal is transmitted using the zone-specific resource allocated to the geographical zone.

15. The communication apparatus according to claim 1, wherein the signal is a broadcast indicating the geographical zone.

16. The communication apparatus according to claim 1, wherein the communication apparatus is a vulnerable road user equipment (VRU-UE).

17. A communication method comprising:
identifying a geographical zone based on a location of a communication apparatus; and
transmitting a signal based on the geographical zone.
